(19) United States
(12) Patent Application Publication
(10) Pub. No.: US 2024/0386177 A1
(43) Pub. Date: Nov. 21, 2024

(54) CIRCUIT DESIGN AND MANUFACTURING HOTSPOT ROOT CAUSE EXTRACTION

(71) Applicant: Siemens Industry Software Inc., Plano, TX (US)

(72) Inventors: Haizhou Yin, Frisco, TX (US); Yuansheng Ma, Fremont, CA (US); Xiaoyuan Qi, Portland, OR (US); Fan Jiang, Beaverton, OR (US)

(73) Assignee: Siemens Industry Software Inc., Plano, TX (US)

(21) Appl. No.: 18/374,063

(22) Filed: Sep. 28, 2023

Related U.S. Application Data
(60) Provisional application No. 63/502,478, filed on May 16, 2023.

(51) Int. Cl. G06F 30/392

(52) U.S. Cl. CPC G06F 30/392; G06F 2119/02

(57) ABSTRACT

Various aspects of the present disclosed technology relate to techniques for hotspot root cause determination. Feature values for a plurality of design/process-related features for each of the layout regions of interest on a layout design are determined. Population ratios for feature value ranges for each of the plurality of design/process-related features are determined based on a number of layout regions of interest having feature values within each of the feature value ranges. Hotspot feature repeater values are determined. Based on the population ratios and the hotspot feature repeater values, a root cause analysis can be performed to determine one or more design/process-related features that are most likely causes for each of a plurality of hotspot layout regions. The information of the one or more design/process-related features can be used to identity other hotspot regions and adjust the layout design or to adjust a manufacturing process.

### FIELD OF THE DISCLOSED TECHNOLOGY

The present disclosed technology relates to the field of circuit design and manufacture. Various implementations of the disclosed technology may be particularly useful for extracting hotspot root causes.

### BACKGROUND OF THE DISCLOSED TECHNOLOGY

As designers and manufacturers continue to shrink the size of circuit components, the shapes reproduced on the substrate though photolithography become smaller and are placed closer together. This reduction in feature size and spacing increases the difficulty of faithfully reproducing the image intended by the design layout onto the substrate and can create defects in the manufactured device. Even with various sophisticated techniques such as resolution enhancement techniques (RETs) and design for manufacturing (DFM), semiconductor manufacturing process will often run into hotspots.

A hotspot, also referred to as a hotspot layout region, can be a layout region that includes a layout feature identified to be a lithographic error by a lithography simulation tool, a layout feature identified to be a hotspot candidate by a design for manufacture tool, or a layout feature corresponding to a physical defect on a chip identified or verified using some semiconductor failure analysis tools such as electrical failure analysis (EFA) and physical failure analysis (PFA) tools. A hotspot may induce manufacturing issues in a lithography process, an etch process, or other fabrication processes. For example, a pinching-type hotspot can result in an open or pinching defect; and a bridging-type hotspot can lead to a bridge defect. Hotspots may include lithographic errors associated with process variability or models used by resonance enhance techniques such as optical proximity correction (OPC).

Achieving high and stable manufacture yields is critical for integrated circuit products to meet quality, reliability and profitability objectives. It is thus important to identify hotspots in a circuit design and their root causes which can improve circuit designing and manufacturing processes.

### BRIEF SUMMARY OF THE DISCLOSED TECHNOLOGY

Various aspects of the present disclosed technology relate to techniques for hotspot root cause determination. In one aspect, there is a method comprising: receiving a layout design, the layout design having layout regions of interest, the layout regions of interest comprising a plurality of hotspot layout regions; determining feature values for a plurality of design/process-related features for each of the layout regions of interest; determining population ratios for feature value ranges for each of the plurality of design/process-related features based on a number of layout regions of interest having feature values within each of the feature value ranges; determining hotspot feature repeater values, a hotspot feature repeater value for a feature value range for a design/process-related feature being associated with a number of the plurality of hotspot layout regions in the feature value range; performing a root cause analysis to determine, for each of the plurality of hotspot layout regions, one or more design/process-related features that are most likely causes of the each of the plurality of hotspot layout regions based on the population ratios and the hotspot feature repeater values; and storing information of the one or more design/process-related features for each of the plurality of hotspot layout regions.

The method may further comprise: identifying hotspot layout regions in another layout design or additional hotspot layout regions in the layout design based on the information of the one or more design/process-related features for each of the plurality of hotspot layout regions; and adjusting the another layout design or the layout design based on the identified hotspot layout regions or the identified additional hotspot layout regions.

The method may further comprise: adjusting a lithographic process based on the information of the one or more design/process-related features for each of the plurality of hotspot layout regions.

The root cause analysis may comprise a decision chain process for each of the plurality of hotspot layout regions. The decision chain process may comprise: selecting a hotspot layout region; determining an initial design/process-related feature that is a most likely cause of the selected hotspot layout region based on a statistic model, the population ratios, and the hotspot feature repeater values; identifying, for subsequent analysis, layout regions of interest having feature values within a feature value range for the initial design/process-related feature in which a feature value for the selected hotspot layout region is; determining another design/process-related feature that is a next most likely cause of the selected hotspot layout region based on the statistic model, updated population ratios, and updated hotspot feature repeater values, the updated population ratios and the updated hotspot feature repeater values derived based on the identified layout regions of interest; and repeating the identifying and the determining another design/process-related feature by replacing the initial design/process-related feature with the another design/process-related feature until a predetermined condition is met.

The predetermined condition may be based on a predetermined p-value.

The statistic model may comprise: computing a probability value for hotspot layout regions having feature values within feature value ranges for each of the process-related features where a corresponding feature value for the selected hotspot layout region is. The computing may be based on a binomial distribution.

In another aspect, there is one or more computer-readable media storing computer-executable instructions for causing one or more processors to perform the above method.

In still another aspect, there is a system, comprising: one or more processors, the one or more processors programmed to perform the above method.

Certain inventive aspects are set out in the accompanying independent and dependent claims. Features from the dependent claims may be combined with features of the independent claims and with features of other dependent claims as appropriate and not merely as explicitly set out in the claims.

Certain objects and advantages of various inventive aspects have been described herein above. Of course, it is to be understood that not necessarily all such objects or advantages may be achieved in accordance with any particular embodiment of the disclosed technology. Thus, for example, those skilled in the art will recognize that the disclosed technology may be embodied or carried out in a manner that achieves or optimizes one advantage or group of advantages as taught herein without necessarily achieving other objects or advantages as may be taught or suggested herein.

### BRIEF DESCRIPTION OF THE DRAWINGS

FIG. 1 illustrates an example of a computing system that may be used to implement various embodiments of the disclosed technology.

FIG. 2 illustrates an example of a multi-core processor unit that may be used to implement various embodiments of the disclosed technology.

FIG. 3 illustrates an example of a hotspot root cause extraction tool 300 that may be implemented according to various embodiments of the disclosed technology.

FIG. 4 illustrates a flowchart showing a process of hotspot root cause determination that may be implemented according to various examples of the disclosed technology.

FIG. 5 illustrates an example of centers of layout regions of interest.

FIG. 6 illustrates an example of a histogram of the layout regions of interest for a design/process-related feature.

FIG. 7 illustrates an example of a histogram of hotspot layout regions for the design/process-related feature shown in FIG. 6.

FIG. 8 illustrates an example of a histogram for both layout regions of interest and hotspot layout regions for another design/process-related feature.

FIG. 9 illustrates a flowchart showing a process of decision chain that may be implemented according to various examples of the disclosed technology.

FIG. 10 illustrates an example of the process of decision chain.

FIG. 11 illustrates an example of Z-score and the binomial probability.

### DETAILED DESCRIPTION OF THE DISCLOSED TECHNOLOGY

### General Considerations

Various aspects of the present disclosed technology relate to techniques for hotspot root cause determination. In the following description, numerous details are set forth for the purpose of explanation. However, one of ordinary skill in the art will realize that the disclosed technology may be practiced without the use of these specific details. In other instances, well-known features have not been described in detail to avoid obscuring the present disclosed technology.

Some of the techniques described herein can be implemented in software instructions stored on a computer-readable medium, software instructions executed on a computer, or some combination of both. Some of the disclosed techniques, for example, can be implemented as part of an electronic design automation (EDA) tool. Such methods can be executed on a single computer or on networked computers.

Although the operations of the disclosed methods are described in a particular sequential order for convenient presentation, it should be understood that this manner of description encompasses rearrangements, unless a particular ordering is required by specific language set forth below. For example, operations described sequentially may in some cases be rearranged or performed concurrently. Moreover, for the sake of simplicity, the disclosed flow charts and block diagrams typically do not show the various ways in which particular methods can be used in conjunction with other methods. Additionally, the detailed description sometimes uses terms like “determine” and “perform” to describe the disclosed methods. Such terms are high-level abstractions of the actual operations that are performed. The actual operations that correspond to these terms will vary depending on the particular implementation and are readily discernible by one of ordinary skill in the art.

Also, as used herein, the term “design” is intended to encompass data describing an entire integrated circuit device. This term also is intended to encompass a smaller group of data describing one or more components of an entire device, however, such as a portion of an integrated circuit device. Still further, the term “design” also is intended to encompass data describing more than one micro device, such as data to be used to form multiple micro devices on a single wafer.

### Illustrative Operating Environment

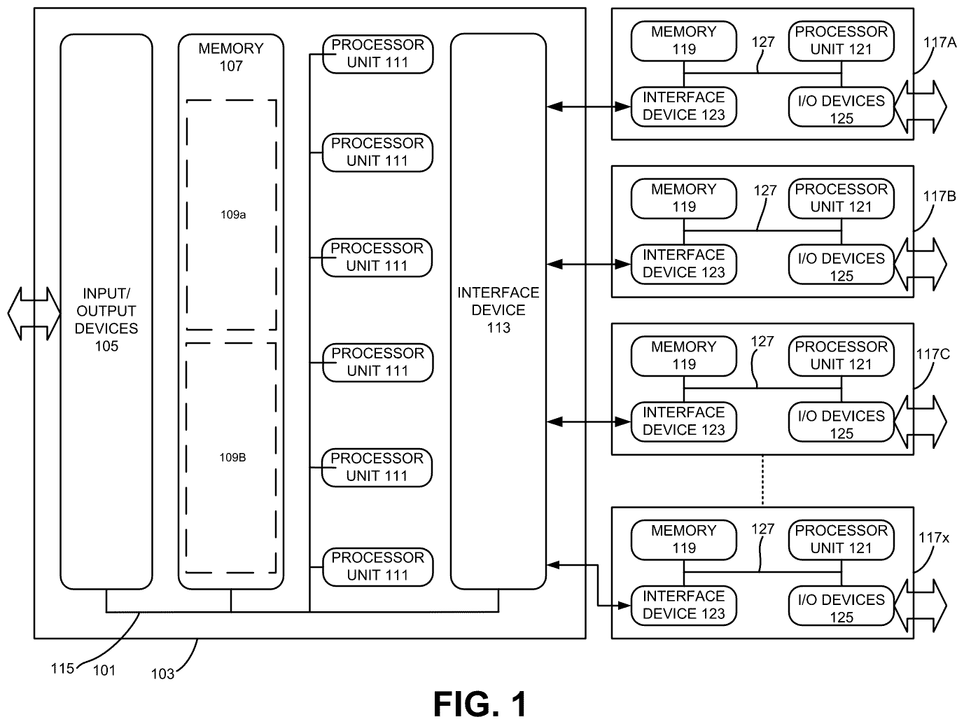

The execution of various electronic design automation processes according to embodiments of the disclosed technology may be implemented using computer-executable software instructions executed by one or more programmable computing devices. Because these embodiments of the disclosed technology may be implemented using software instructions, the components and operation of a generic programmable computer system on which various embodiments of the disclosed technology may be employed will first be described. Further, because of the complexity of some electronic design automation processes and the large size of many circuit designs, various electronic design automation tools are configured to operate on a computing system capable of simultaneously running multiple processing threads. The components and operation of a computer network having a host or master computer and one or more remote or servant computers therefore will be described with reference to FIG. 1. This operating environment is only one example of a suitable operating environment, however, and is not intended to suggest any limitation as to the scope of use or functionality of the disclosed technology.

In FIG. 1, the computer network 101 includes a master computer 103. In the illustrated example, the master computer 103 is a multi-processor computer that includes a plurality of input and output devices 105 and a memory 107. The input and output devices 105 may include any device for receiving input data from or providing output data to a user. The input devices may include, for example, a keyboard, microphone, scanner or pointing device for receiving input from a user. The output devices may then include a display monitor, speaker, printer or tactile feedback device. These devices and their connections are well known in the art, and thus will not be discussed at length here.

The memory 107 may similarly be implemented using any combination of computer readable media that can be accessed by the master computer 103. The computer readable media may include, for example, microcircuit memory devices such as read-write memory (RAM), read-only memory (ROM), electronically erasable and programmable read-only memory (EEPROM) or flash memory microcircuit devices, CD-ROM disks, digital video disks (DVD), or other optical storage devices. The computer readable media may also include magnetic cassettes, magnetic tapes, magnetic disks or other magnetic storage devices, punched media, holographic storage devices, or any other medium that can be used to store desired information.

As will be discussed in detail below, the master computer 103 runs a software application for performing one or more operations according to various examples of the disclosed technology. Accordingly, the memory 107 stores software instructions 109A that, when executed, will implement a software application for performing one or more operations. The memory 107 also stores data 109B to be used with the software application. In the illustrated embodiment, the data 109B contains process data that the software application uses to perform the operations, at least some of which may be parallel.

The master computer 103 also includes a plurality of processor units 111 and an interface device 113. The processor units 111 may be any type of processor device that can be programmed to execute the software instructions 109A, but will conventionally be a microprocessor device. For example, one or more of the processor units 111 may be a commercially generic programmable microprocessor, such as Intel® Pentium® or Xeon™ microprocessors, Advanced Micro Devices Athlon™ microprocessors or Motorola 68K/Coldfire® microprocessors. Alternately or additionally, one or more of the processor units 111 may be a custom-manufactured processor, such as a microprocessor designed to optimally perform specific types of mathematical operations. The interface device 113, the processor units 111, the memory 107 and the input/output devices 105 are connected together by a bus 115.

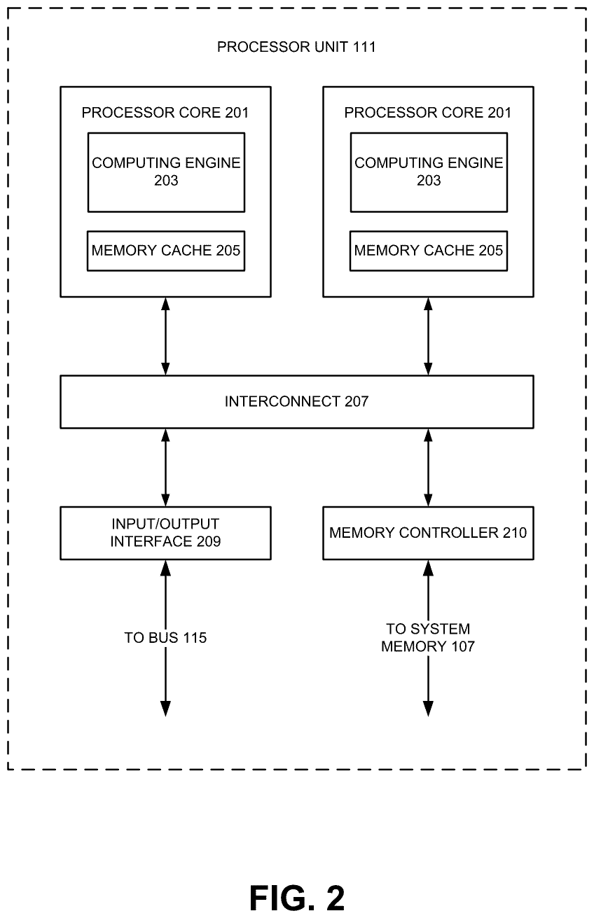

With some implementations of the disclosed technology, the master computing device 103 may employ one or more processing units 111 having more than one processor core. Accordingly, FIG. 2 illustrates an example of a multi-core processor unit 111 that may be employed with various embodiments of the disclosed technology. As seen in this figure, the processor unit 111 includes a plurality of processor cores 201. Each processor core 201 includes a computing engine 203 and a memory cache 205. As known to those of ordinary skill in the art, a computing engine contains logic devices for performing various computing functions, such as fetching software instructions and then performing the actions specified in the fetched instructions. These actions may include, for example, adding, subtracting, multiplying, and comparing numbers, performing logical operations such as AND, OR, NOT and XOR, and retrieving data. Each computing engine 203 may then use its corresponding memory cache 205 to quickly store and retrieve data and/or instructions for execution.

Each processor core 201 is connected to an interconnect 207. The particular construction of the interconnect 207 may vary depending upon the architecture of the processor unit 111. With some processor cores 201, such as the Cell microprocessor created by Sony Corporation, Toshiba Corporation and IBM Corporation, the interconnect 207 may be implemented as an interconnect bus. With other processor units 111, however, such as the Opteron™ and Athlon™ dual-core processors available from Advanced Micro Devices of Sunnyvale, California, the interconnect 207 may be implemented as a system request interface device. In any case, the processor cores 201 communicate through the interconnect 207 with an input/output interface 209 and a memory controller 210. The input/output interface 209 provides a communication interface between the processor unit 111 and the bus 115. Similarly, the memory controller 210 controls the exchange of information between the processor unit 111 and the system memory 107. With some implementations of the disclosed technology, the processor units 111 may include additional components, such as a high-level cache memory accessible shared by the processor cores 201.

While FIG. 2 shows one illustration of a processor unit 111 that may be employed by some embodiments of the disclosed technology, it should be appreciated that this illustration is representative only, and is not intended to be limiting. Also, with some implementations, a multi-core processor unit 111 can be used in lieu of multiple, separate processor units 111. For example, rather than employing six separate processor units 111, an alternate implementation of the disclosed technology may employ a single processor unit 111 having six cores, two multi-core processor units each having three cores, a multi-core processor unit 111 with four cores together with two separate single-core processor units 111, etc.

Returning now to FIG. 1, the interface device 113 allows the master computer 103 to communicate with the servant computers 117A, 117B, 117C . . . 117x through a communication interface. The communication interface may be any suitable type of interface including, for example, a conventional wired network connection or an optically transmissive wired network connection. The communication interface may also be a wireless connection, such as a wireless optical connection, a radio frequency connection, an infrared connection, or even an acoustic connection. The interface device 113 translates data and control signals from the master computer 103 and each of the servant computers 117 into network messages according to one or more communication protocols, such as the transmission control protocol (TCP), the user datagram protocol (UDP), and the Internet protocol (IP). These and other conventional communication protocols are well known in the art, and thus will not be discussed here in more detail.

Each servant computer 117 may include a memory 119, a processor unit 121, an interface device 123, and, optionally, one more input/output devices 125 connected together by a system bus 127. As with the master computer 103, the optional input/output devices 125 for the servant computers 117 may include any conventional input or output devices, such as keyboards, pointing devices, microphones, display monitors, speakers, and printers. Similarly, the processor units 121 may be any type of conventional or custom-manufactured programmable processor device. For example, one or more of the processor units 121 may be commercially generic programmable microprocessors, such as Intel® Pentium® or Xeon™ microprocessors, Advanced Micro Devices Athlon™ microprocessors or Motorola 68K/Coldfire® microprocessors. Alternately, one or more of the processor units 121 may be custom-manufactured processors, such as microprocessors designed to optimally perform specific types of mathematical operations. Still further, one or more of the processor units 121 may have more than one core, as described with reference to FIG. 2 above. For example, with some implementations of the disclosed technology, one or more of the processor units 121 may be a Cell processor. The memory 119 then may be implemented using any combination of the computer readable media discussed above. Like the interface device 113, the interface devices 123 allow the servant computers 117 to communicate with the master computer 103 over the communication interface.

In the illustrated example, the master computer 103 is a multi-processor unit computer with multiple processor units 111, while each servant computer 117 has a single processor unit 121. It should be noted, however, that alternate implementations of the disclosed technology may employ a master computer having single processor unit 111. Further, one or more of the servant computers 117 may have multiple processor units 121, depending upon their intended use, as previously discussed. Also, while only a single interface device 113 or 123 is illustrated for both the master computer 103 and the servant computers, it should be noted that, with alternate embodiments of the disclosed technology, either the computer 103, one or more of the servant computers 117, or some combination of both may use two or more different interface devices 113 or 123 for communicating over multiple communication interfaces.

With various examples of the disclosed technology, the master computer 103 may be connected to one or more external data storage devices. These external data storage devices may be implemented using any combination of computer readable media that can be accessed by the master computer 103. The computer readable media may include, for example, microcircuit memory devices such as read-write memory (RAM), read-only memory (ROM), electronically erasable and programmable read-only memory (EEPROM) or flash memory microcircuit devices, CD-ROM disks, digital video disks (DVD), or other optical storage devices. The computer readable media may also include magnetic cassettes, magnetic tapes, magnetic disks or other magnetic storage devices, punched media, holographic storage devices, or any other medium that can be used to store desired information. According to some implementations of the disclosed technology, one or more of the servant computers 117 may alternately or additionally be connected to one or more external data storage devices. Typically, these external data storage devices will include data storage devices that also are connected to the master computer 103, but they also may be different from any data storage devices accessible by the master computer 103.

It also should be appreciated that the description of the computer network illustrated in FIG. 1 and FIG. 2 is provided as an example only, and it not intended to suggest any limitation as to the scope of use or functionality of alternate embodiments of the disclosed technology.

### Circuit Design Flow

Electronic circuits, such as integrated microcircuits, are used in a variety of products such as automobiles, personal computers, data center servers, and smart phones. Designing and fabricating integrated circuit devices typically involves many steps, sometimes referred to as a “design flow.” The particular steps of a design flow often are dependent upon the type of integrated circuit, its complexity, the design team, and the integrated circuit fabricator or foundry that will manufacture the microcircuit. Typically, software and hardware “tools” verify the design at various stages of the design flow by running software simulators and/or hardware emulators. These steps aid in the discovery of errors in the design, and allow the designers and engineers to correct or otherwise improve the design.

Several steps are common to most design flows. Initially, the specification for a new circuit is transformed into a logical design, sometimes referred to as a register transfer level (RTL) description of the circuit. With this logical design, the circuit is described in terms of both the exchange of signals between hardware registers and the logical operations that are performed on those signals. The logical design typically employs a Hardware Design Language (HDL), such as the Very high speed integrated circuit Hardware Design Language (VHDL). The logic of the circuit is then analyzed, to confirm that it will accurately perform the functions desired for the circuit. This analysis is sometimes referred to as “functional verification.”

After the accuracy of the logical design is confirmed, it is converted into a device design by synthesis software. The device design, which is typically in the form of a schematic or netlist, describes the specific electronic devices (such as transistors, resistors, and capacitors) that will be used in the circuit, along with their interconnections. This device design generally corresponds to the level of representation displayed in conventional circuit diagrams. The relationships between the electronic devices are then analyzed, to confirm that the circuit described by the device design will correctly perform the desired functions. This analysis is sometimes referred to as “formal verification.” Additionally, preliminary timing estimates for portions of the circuit are often made at this stage, using an assumed characteristic speed for each device, and incorporated into the verification process.

Once the components and their interconnections are established, the design is again transformed, this time into a physical design that describes specific geometric elements. This type of design often is referred to as a “layout” design. The geometric elements, which typically are polygons, define the shapes that will be created in various layers of material to manufacture the circuit. For digital circuits, automated place and route tools will be used to define the physical layouts, especially of wires that will be used to interconnect the circuit devices. Each layer of the microcircuit will have a corresponding layer representation in the layout design, and the geometric shapes described in a layer representation will define the relative locations of the circuit elements that will make up the circuit device. For example, shapes in the layer representation of a metal layer will define the locations of the metal wires used to connect the circuit devices. Custom layout editors, such as Mentor Graphics' IC Station or Cadence's Virtuoso, allow a designer to custom design the layout, which is mainly used for analog, mixed-signal, RF, and standard-cell designs.

Integrated circuit layout descriptions can be provided in many different formats. The Graphic Data System II (GDSII) format is a popular format for transferring and archiving two-dimensional graphical IC layout data. Among other features, it contains a hierarchy of structures, each structure containing layout elements (e.g., polygons, paths or poly-lines, circles and textboxes). Other formats include an open source format named Open Access, Milkyway by Synopsys, Inc., EDDM by Mentor Graphics, Inc., and the more recent Open Artwork System Interchange Standard (OASIS) proposed by Semiconductor Equipment and Materials International (SEMI). These various industry formats are used to define the geometrical information in IC layout designs that are employed to manufacture integrated circuits. Once the microcircuit device design is finalized, the layout portion of the design can be used by fabrication tools to manufacture the device using a photolithographic process.

Typically, a designer will perform a number of verification processes on the layout design. For example, the layout design may be analyzed to confirm that it complies with various design requirements, such as minimum spacing between geometric elements and minimum linewidths of geometric elements. In this process, a DRC (design rule checking) tool takes as input a layout in the GDSII standard format and a list of rules specific to the semiconductor process chosen for fabrication. A set of rules for a particular process is referred to as a run-set, rule deck, or just a deck. An example of the format of a rule deck is the Standard Verification Rule Format (SVRF) by Mentor Graphics Corporation.

The layout design are also analyzed to confirm that it accurately represents the circuit devices and their relationships described in the device design. A conventional LVS (layout versus schematic) process comprises two phases: extraction and comparison. In the extraction phase, a netlist is extracted from the layout design. The netlist includes not only types of and connectivity between the devices but also device parameters. In the comparison phase, the LVS tool compares the extracted netlist with the source netlist which is taken from the circuit schematic, and reports violations if any. LVS can be augmented by formal equivalence checking, which checks whether two circuits perform exactly the same function without demanding isomorphism.

As designers and manufacturers continue to shrink the size of circuit components, the shapes reproduced on the substrate through photolithography become smaller and are placed closer together. This reduction in feature size and spacing increases the difficulty of faithfully reproducing the image onto the substrate intended by the design layout and can create flaws in the manufactured device. To address the problem, one or more resolution enhancement techniques are often employed to improve the resolution of the image that the mask forms on the substrate during the photolithographic process.

One of resolution enhancement techniques, “optical proximity correction” or “optical process correction” (OPC), tries to compensate for light diffraction effects. When light illuminates the photomask, the transmitted light diffracts. The higher spatial frequencies the regions of the mask have, the higher angles the light diffracts at. The resolution limits of the lens in a photolithographic system make the lens act effectively as a low-pass filter for the various spatial frequencies in the two-dimensional layout. This can lead to optical proximity effects such as a pull-back of line-ends from their desired position, corner rounding and a bias between isolated and dense structures. The optical proximity correction can adjust the amplitude of the light transmitted through a lithographic mask by modifying the layout design data employed to create the photomask. For example, edges in the layout design may be adjusted to make certain portions of the geometric elements larger or smaller, in accordance with how much additional light exposure (or lack of exposure) is desired at certain points on the substrate. When these adjustments are appropriately calibrated, overall pattern fidelity is greatly improved, thereby reducing optical proximity effects.

Once a layout design is processed by resolution enhancement techniques, a verification technique based on lithography simulation can be performed to determine how the layout design will be printed on silicon. Manufacture process variability can have a dramatic effect on yield. The simulation-based verification can detect lithographic errors or marginalities caused by process variability and ensure that OPC corrections are adequate.

### Hotspot Root Cause Extraction Tool

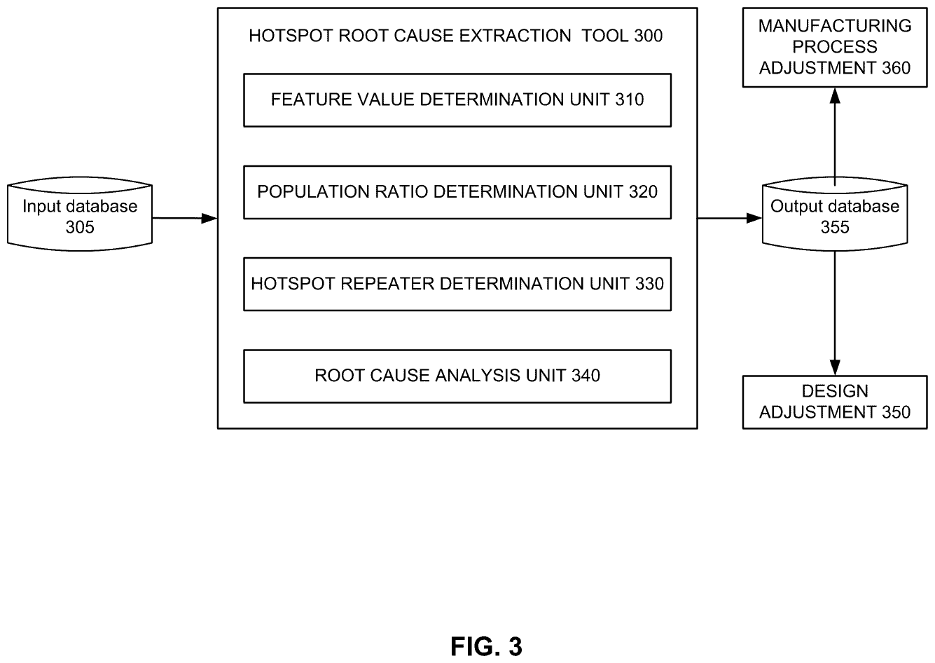

FIG. 3 illustrates an example of a hotspot root cause extraction tool 300 that may be implemented according to various embodiments of the disclosed technology. As seen in this figure, the hotspot root cause extraction tool 300 includes a feature value determination unit 310, a population ratio determination unit 320, a hotspot repeater determination unit 330, and a root cause analysis unit 340. Various implementations of the hotspot root cause extraction tool 300 may cooperate with (or incorporate) one or more of a design adjustment module 350, a manufacturing process adjustment module 360, an input database 305 and an output database 355.

As will be discussed in more detail below, the hotspot root cause extraction tool 300 can receive a layout design from the input database 305. The layout design has layout regions of interest, and the layout regions of interest comprise a plurality of hotspot layout regions. The feature value determination unit 310 can determine feature values for a plurality of design/process-related features for each of the layout regions of interest. The population ratio determination unit 320 can determine population ratios for feature value ranges for each of the plurality of design/process-related features based on a number of layout regions of interest having feature values within each of the feature value ranges. The hotspot repeater determination unit 330 can determine hotspot feature repeater values, a hotspot feature repeater value for a feature value range for a design/process-related feature being associated with a number of plurality of hotspot layout regions in the feature value range. The root cause analysis unit 340 can perform a root cause analysis to determine, for each of the plurality of hotspot layout regions, one or more design/process-related features that are most likely causes of the each of the plurality of hotspot layout regions based on the population ratios and the hotspot feature repeater values. The hotspot root cause extraction tool 300 can store information of the one or more design/process-related features for each of the plurality of hotspot layout regions in the output database 355. The design adjustment module 350 can identify hotspot layout regions in another layout design or additional hotspot layout regions in the layout design based on the information of the one or more design/process-related features for each of the plurality of hotspot layout regions, and can adjust the another layout design or the layout design based on the identified hotspot layout regions or the identified additional hotspot layout regions. The manufacturing process adjustment module 360 can adjust a manufacturing process based on the information of the one or more design/process-related features for each of the plurality of hotspot layout regions.

As previously noted, various examples of the disclosed technology may be implemented by one or more computing systems, such as the computing system illustrated in FIGS. 1 and 2. Accordingly, one or more of the feature value determination unit 310, the population ratio determination unit 320, the hotspot repeater determination unit 330, and the root cause analysis unit 340 may be implemented by executing programming instructions on one or more processors in one or more computing systems, such as the computing system illustrated in FIGS. 1 and 2. Correspondingly, some other embodiments of the disclosed technology may be implemented by software instructions, stored on a non-transitory computer-readable medium, for instructing one or more programmable computers/computer systems to perform the functions of one or more of the feature value determination unit 310, the population ratio determination unit 320, the hotspot repeater determination unit 330, and the root cause analysis unit 340. As used herein, the term “non-transitory computer-readable medium” refers to computer-readable medium that are capable of storing data for future retrieval, and not propagating electro-magnetic waves. The non-transitory computer-readable medium may be, for example, a magnetic storage device, an optical storage device, or a solid state storage device.

It also should be appreciated that, while the feature value determination unit 310, the population ratio determination unit 320, the hotspot repeater determination unit 330, and the root cause analysis unit 340 are shown as separate units in FIG. 3, a single computer (or a single processor within a master computer) or a single computer system may be used to implement some or all of these units at different times, or components of these units at different times.

With various examples of the disclosed technology, the input database 305 and the output database 355 may be implemented using any suitable computer readable storage device. That is, either of the input database 305 and the output database 355 may be implemented using any combination of computer readable storage devices including, for example, microcircuit memory devices such as read-write memory (RAM), read-only memory (ROM), electronically erasable and programmable read-only memory (EEPROM) or flash memory microcircuit devices, CD-ROM disks, digital video disks (DVD), or other optical storage devices. The computer readable storage devices may also include magnetic cassettes, magnetic tapes, magnetic disks or other magnetic storage devices, holographic storage devices, or any other non-transitory storage medium that can be used to store desired information. While the input database 305 and the output database 355 are shown as separate units in FIG. 3, a single data storage medium may be used to implement some or all of these databases.

### Hotspot Root Cause Determination

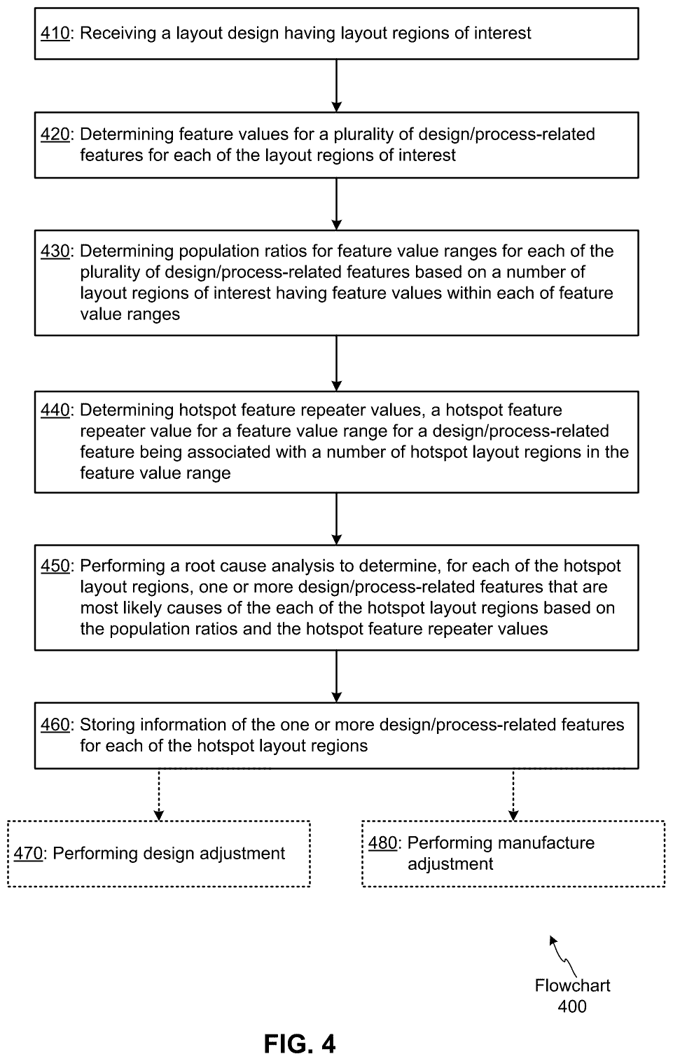

FIG. 4 illustrates a flowchart 400 showing a process of hotspot root cause determination that may be implemented according to various examples of the disclosed technology. For ease of understanding, methods of hotspot root cause determination that may be employed according to various embodiments of the disclosed technology will be described with reference to the hotspot root cause extraction tool 300 in FIG. 3 and the flow chart 400 illustrated in FIG. 4. It should be appreciated, however, that alternate implementations of a hotspot root cause extraction tool may be used to perform the methods of hotspot root cause determination illustrated by the flow chart 400 according to various embodiments of the disclosed technology. Likewise, the hotspot root cause extraction tool 300 may be employed to perform other methods of hotspot root cause determination according to various embodiments of the disclosed technology.

In operation 410 of the flow chart 400, the hotspot root cause extraction tool 300 receives a layout design from the input database 305. The layout design may be in the GDSII standard format or the OASIS standard format. The layout design may be derived from a circuit design using a place and route tool. Alternatively, the layout design may be one that has been processed by an optical proximity correction tool. The layout design may represent a full-chip design or a portion of a full-chip design.

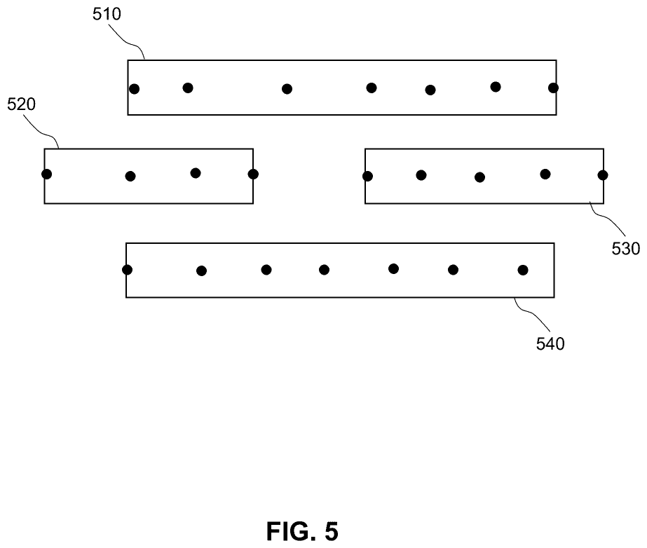

The layout design has layout regions of interest. The layout regions of interest may be selected based on analysis needs. For example, the center of a layout region can be set at a metal line end, a via, a metal line center, or between metal lines. FIG. 5 illustrates an example of centers of layout regions of interest. The figure includes four rectangle layout shapes 510-540. These rectangle layout shapes 510-540 represent conducting metal lines. On each of the metal lines centers of layout regions of interest are represented by black dots.

The size of a layout region can be set based upon feature collection methods or the range of light diffraction. Printing errors of a layout feature can be caused by its neighboring layout features. How far away a neighboring layout feature can affect the printability depends at least in part on the wavelength of the light source used for lithography. The size of a layout region can thus be set as several multiples of the wavelength or the minimum line spacing that can be achieved in a particular technology node. In a state-of-the-art deep ultraviolet (DUV) lithography process, the light source is 193 nm excimer lasers. The minimum metal line width in single exposure for the 7 nm or 10 nm technology node is about 40 nm. Accordingly, the layout region can be set as, for example, 200 nm in radius for a circle shape or 400 nm in side length for a square shape.

The layout regions of interest on the received layout design comprise a plurality of hotspot layout regions. As mentioned previously, a hotspot layout region can be a layout region that includes a layout feature identified to be a lithographic error by a lithography simulation tool, a layout feature identified to be a hotspot candidate by a design for manufacture tool, or a layout feature corresponding to a physical defect on a chip identified or verified using some semiconductor failure analysis tools such as electrical failure analysis (EFA) and physical failure analysis (PFA) tools. A hotspot may induce manufacturing issues in a lithography process, an etch process, or other fabrication processes. For example, a pinching-type hotspot can result in an open or pinching defect; and a bridging-type hotspot can lead to a bridge defect. Hotspots can include lithographic errors associated with process variability or models used by resolution enhance techniques such as optical proximity correction (OPC).

Referring back to FIG. 4, in operation 420, the feature value determination unit 310 determines feature values for a plurality of design/process-related features for each of the layout regions of interest. The plurality of design/process-related features may comprise density-based design/process-related features. For example, a density-based design/process-related feature can correspond to a ring in a set of rings with sharing a center but having different radius and not overlapping with each other. The common center may be the center of a layout region of interest. To derive values of the density-based design/process-related features for a layout region of interest, the feature value determination unit 310 can place the set of rings centered at the center of a layout region of interest and compute the percentage of area in each of the rings occupied by layout features in the layout region of interest.

Additionally or alternatively, the plurality of design/process-related features can comprise other types of features such as geometry-based features or lithography-related features. Examples of the geometry-based features are critical dimensions and fragment lengths. Lithography-related features include those associated with the optical models used for lithographic simulation which capture properties like the light intensity information. Another type of the lithography-related features may be related to resist models. The feature value determination unit 310 may extract feature values of geometry-based features directly from the layout design and compute feature values of lithography-related features based on the optical models/resist models used in optical proximity correction.

The plurality of design/process-related features can be selected to contain attributes encapsulating the domain knowledge of both design and process and to include information on design layout, the lithography and etch process models, OPC/RET recipes, and fab metrology equipment. Users can also define their own design/process-related features.

In operation 430, the population ratio determination unit 320 determines population ratios for feature value ranges for each of the plurality of design/process-related features based on a number of layout regions of interest having feature values within each of the feature value ranges. The population ratios may be derived by dividing the number of layout regions of interest having feature values within each of the feature value ranges by the total number of the layout regions of interest. A feature value range is set to be around the feature value of a selected hotspot layout region. The size of a feature value range could be selected to be a fraction of the standard deviation of the total layout regions for that particular design/process-related feature. Alternatively or additionally, the balance of population ratio and the number of hotspots falling inside the range may be considered while deciding the feature value range.

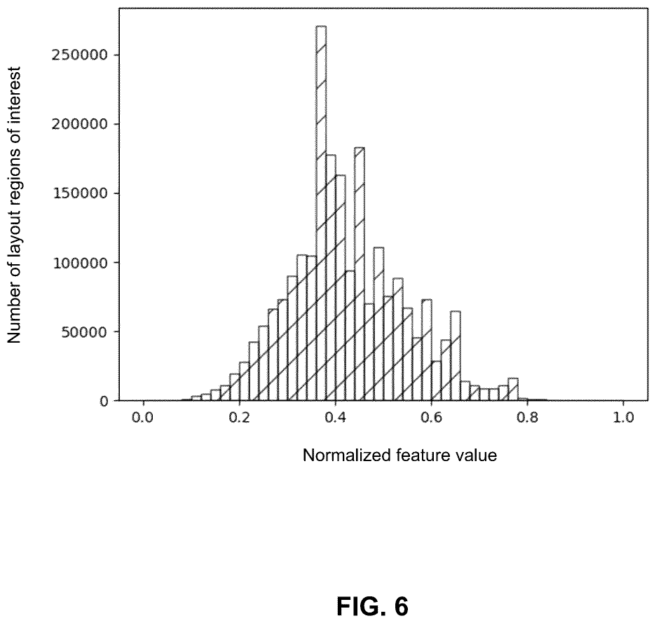

FIG. 6 illustrates an example of a histogram of the layout regions of interest for a design/process-related feature. The horizontal axis represents a normalized feature value for the design/process-related feature, and the vertical axis represents the number of the layout regions of interest.

Referring back to FIG. 4, in operation 440, the hotspot repeater determination unit 330 determines hotspot feature repeater values. A hotspot feature repeater value for a feature value range for a design/process-related feature is associated with a number of hotspot layout regions in the feature value range. For a particular design/process-related feature, a feature value can be derived for a specific hotspot layout region. This particular feature value is in a particular feature value range. The hotspot feature repeaters for the specific hotspot layout region are the hotspot layout regions having feature values in that particular feature value range. Please note that the feature value ranges used by the hotspot repeater determination unit 330 are the same as the feature value ranges used by the population ratio determination unit 320.

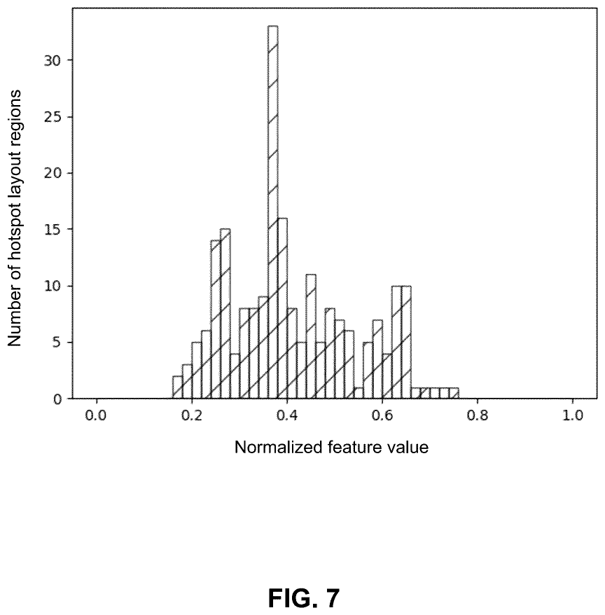

FIG. 7 illustrates an example of a histogram of hotspot layout regions for the design/process-related feature shown in FIG. 6. Like FIG. 6, the horizontal axis represents a normalized feature value for the design/process-related feature. However, the vertical axis represents the number of the hotspot layout regions rather than the number of the layout regions of interest. As shown in the two figures, the number of the layout regions of interest in a feature value range can reach almost 350,000 whereas the maximum number of hotspot layout regions in a feature value range is fewer than 40. The comparison of the two histograms shows that the distribution of the hotspot layout regions roughly matches the distribution of the layout regions of interest for this particular design/process-related feature. Therefore, the hotspot layout regions are distributed randomly with respect to this design/process-related feature and thus it cannot be associated with a root cause for causing some or all of the hotspot layout regions.

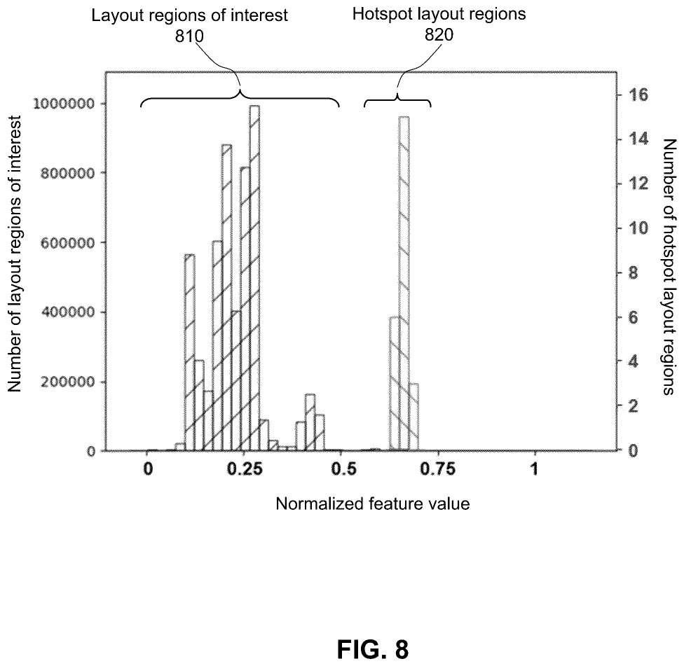

FIG. 8 illustrates an example of a histogram for both layout regions of interest 810 and hotspot layout regions 820 for another design/process-related feature. The horizontal axis represents a normalized feature value for this design/process-related feature, the left vertical axis represents the number of layout regions of interest, and the right vertical axis represents the number of hotspot layout regions. The two vertical axes are not to the same scale. The figure shows that the hotspot layout regions 820 are populated in a part of the histogram where the population of the layout regions of interest is extremely small. The fact that a hotspot layout region falls in a very low population density region in the feature space indicates that it is less random in that feature space i.e. this design/process-related feature likely captures the underlying failure mechanism of the hotspot.

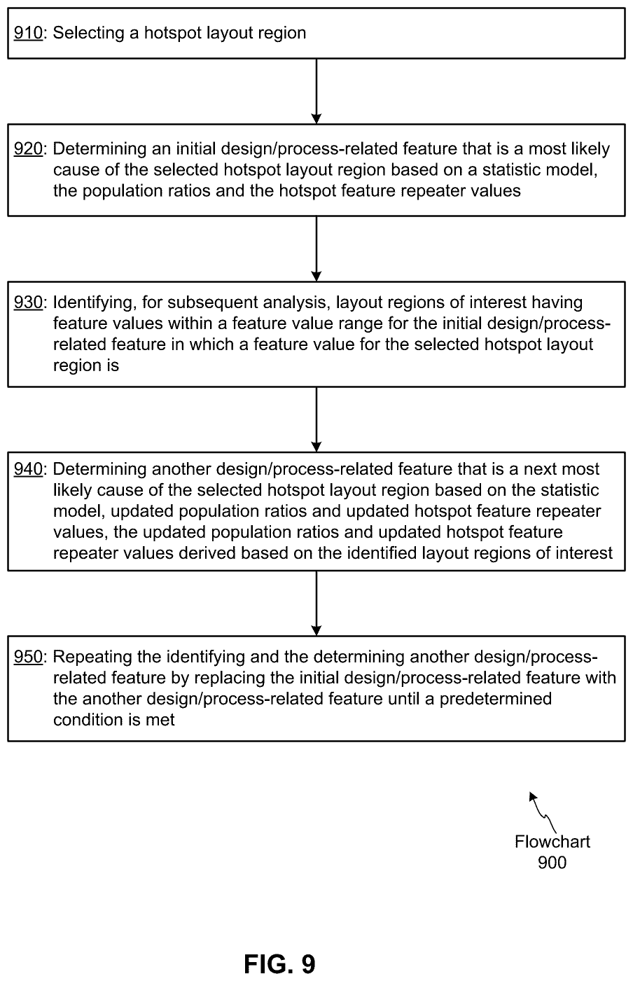

Referring back to FIG. 4, in operation 450, the root cause analysis unit 340 performs a root cause analysis to determine, for each of the plurality of hotspot layout regions, one or more design/process-related features that are most likely causes of the each of the plurality of hotspot layout regions based on the population ratios and the hotspot feature repeater values. The root cause analysis may comprise a decision chain process for each of the plurality of hotspot layout regions. FIG. 9 illustrates a flowchart 900 showing a process of decision chain that may be implemented according to various examples of the disclosed technology. In operation 910, a hotspot layout region is selected. In operation 920, an initial design/process-related feature that is a most likely cause of the selected hotspot layout region is determined based on a statistic model, the population ratios, and the hotspot feature repeater values. In operation 930, layout regions of interest having feature values within a feature value range for the initial design/process-related feature where a feature value for the selected hotspot layout region is determined for subsequent analysis. In operation 940, another design/process-related feature that is a next most likely cause of the selected hotspot layout region is determined based on the statistic model, updated population ratios, and updated hotspot feature repeater values. Here, the updated population ratios and the updated hotspot feature repeater values are derived using the same techniques as the ones used in the operations 430 and 440 but replacing the layout regions of interest with the identified layout regions of interest. In operation 950, the identifying and the determining another process-related feature are repeated by replacing the initial design/process-related feature with the another design/process-related feature until a predetermined condition is met. The predetermined conditions could be based on a required minimum number of the identified layout regions (e.g. 100), a statistical metric (e.g. a p-value which will be explained later), or heuristics.

Different statistic models may be employed. According to some implementation of the disclosed technology, the statistic model can comprise: computing a probability value for hotspot layout regions having feature values within feature value ranges for each of the process-related features where a corresponding feature value for the selected hotspot layout region is. The smaller the probability value is, the more confident it is systematic. The probability value may be computed based on a binomial distribution:

$$( \begin{matrix}n \\ x\end{matrix} ) {p}^{x} {q}^{n - x}$$

Here, x is the hotspot feature repeater value for the selected hotspot layout region, n is the total number of the hotspot layout regions minus one, p is the population ratio for the feature value range where the selected hotspot layout region has the feature value, and q=1−p.

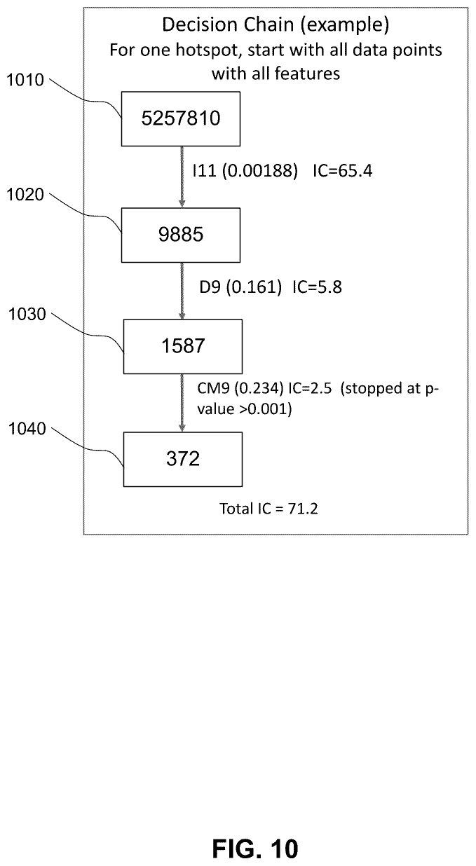

FIG. 10 shows an example of the process of decision chain. In an initial round of analysis 1010, the number of the layout regions of interest is 5,257,810 and a design/process-related feature (I11) which has a population ratio of 0.00188 is determined to be the most likely cause of the selected hotspot layout region. In a next round of analysis 1020, the number of the layout regions of interest is down to 9,885 and a design/process-related feature (D9) which has a population ratio of 0.161 is determined to be the next most likely cause of the selected hotspot layout region. The number 9885 is derived by 5.25M×0.00188 because the population ratio is 0.00188 for I11. In a third round of analysis 1030, the number of the layout regions of interest is down to 1,587 and a design/process-related feature (CM9) is found to have a population ratio of 0.234. In a fourth round of analysis 1040, the analysis stops because a predetermined condition (p-value>0.001) is met at the previous round which will be explained below. As such, the design/process-related features I11 and D9 may be deemed as the most likely causes of the selected hotspot layout region. In some other embodiments, in the first round of analysis, a feature other than I11 may selected based on, for example, heuristics.

Sometimes, we can use Information Content (IC)=log₁₀(1/probability). IC can indicate the confidence of this decision chain process. And IC value can be used to optimize the feature value range around the selected hotspot layout region for population ratio calculation. The corresponding IC values for each of the three rounds of analysis 1010-1030 are shown in FIG. 10 as well.

The predetermined condition may be based on comparing p-values with a predetermined p-value. The p-value can be derived using Z-score:

(Number of observed repeaters−Number of expected)/STD

where STD is the standard deviation of the feature repeaters:

sqrt((N−1)*p*(1−p)); and

Number of expected can be derived as follows:

$$( N - 1 ) * p$$

where (N−1) is the count of other hotspots, and p is the population ratio for the feature value range.

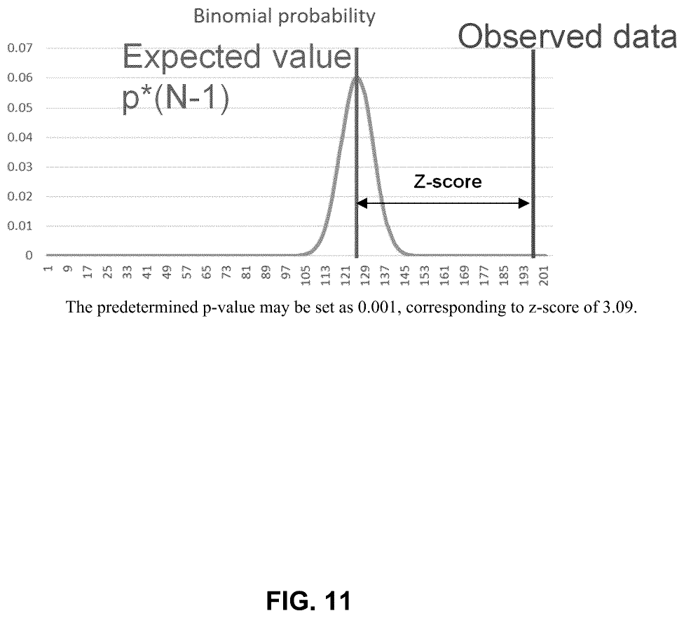

The predetermined p-value of 0.001 corresponds to Z-score of 3.09. The Z-score represents how many standard deviations an observed value is away from the expected value. FIG. 11 illustrates an example of Z-score and the binomial probability.

Referring back to FIG. 4, in operation 460, the hotspot root cause extraction tool 300 stores information of the one or more design/process-related features for each of the plurality of hotspot layout regions in the output database 355. The information of the one or more design/process-related features can comprise not only the one or more process-related features identified by each step of the decision chain process but also those in each step having Information Content values greater than the value for the process-related feature identified in the next step according to some embodiments of the disclosed technology. It can comprise not only the identities the one or more process-related features but also their corresponding feature value ranges.

Optionally, in operation 470, the design adjustment module 350 can identify hotspot layout regions in another layout design or additional hotspot layout regions in the layout design based on the information of the one or more process-related features for each of the plurality of hotspot layout regions (hotspot layout region models) and adjust the another layout design or the layout design to make it free of hotspots.

Optionally, in operation 480, the manufacturing process adjustment module 360 can adjust a manufacturing process based on the information of the one or more design/process-related features for each of the plurality of hotspot layout regions.

### Conclusion

Having illustrated and described the principles of the disclosed technology, it will be apparent to those skilled in the art that the disclosed embodiments can be modified in arrangement and detail without departing from such principles. In view of the many possible embodiments to which the principles of the disclosed technologies can be applied, it should be recognized that the illustrated embodiments are only preferred examples of the technologies and should not be taken as limiting the scope of the disclosed technology. Rather, the scope of the disclosed technology is defined by the following claims and their equivalents. We therefore claim as our disclosed technology all that comes within the scope and spirit of these claims.

What is claimed is:

1. A method, executed by at least one processor of a computer, comprising:
receiving a layout design, the layout design having layout regions of interest, the layout regions of interest comprising a plurality of hotspot layout regions;
determining feature values for a plurality of design/process-related features for each of the layout regions of interest;
determining population ratios for feature value ranges for each of the plurality of design/process-related features based on a number of layout regions of interest having feature values within each of the feature value ranges;
determining hotspot feature repeater values, a hotspot feature repeater value for a feature value range for a design/process-related feature being associated with a number of hotspot layout regions in the feature value range;
performing a root cause analysis to determine, for each of the plurality of hotspot layout regions, one or more design/process-related features that are most likely causes of the each of the plurality of hotspot layout regions based on the population ratios and the hotspot feature repeater values; and
storing information of the one or more design/process-related features for each of the plurality of hotspot layout regions.

2. The method recited in claim 1, further comprising:
identifying hotspot layout regions in another layout design or additional hotspot layout regions in the layout design based on the information of the one or more design/process-related features for each of the plurality of hotspot layout regions; and
adjusting the another layout design or the layout design based on the identified hotspot layout regions or the identified additional hotspot layout regions.

3. The method recited in claim 1, further comprising:
adjusting a manufacturing process based on the information of the one or more design/process-related features for each of the plurality of hotspot layout regions.

4. The method recited in claim 1, wherein the root cause analysis comprises a decision chain process for each of the plurality of hotspot layout regions.

5. The method recited in claim 4, wherein the decision chain process comprises:
selecting a hotspot layout region;
determining an initial design/process-related feature that is a most likely cause of the selected hotspot layout region based on a statistic model, the population ratios, and the hotspot feature repeater values;
identifying, for subsequent analysis, layout regions of interest having feature values within a feature value range for the initial design/process-related feature in which a feature value for the selected hotspot layout region is;
determining another design/process-related feature that is a next most likely cause of the selected hotspot layout region based on the statistic model, updated population ratios, and updated hotspot feature repeater values, the updated population ratios and the updated hotspot feature repeater values derived based on the identified layout regions of interest; and
repeating the identifying and the determining another design/process-related feature by replacing the initial design/process-related feature with the another design/process-related feature until a predetermined condition is met.

6. The method recited in claim 5, wherein the predetermined condition is based on a predetermined p-value.

7. The method recited in claim 5, wherein the statistic model comprises:
computing a probability value for hotspot layout regions having feature values within feature value ranges for each of the process-related features where a corresponding feature value for the selected hotspot layout region is.

8. The method recited in claim 7, wherein the computing is based on a binomial distribution.

9. One or more computer-readable media storing computer-executable instructions for causing one or more processors to perform a method, the method comprising:
receiving a layout design, the layout design having layout regions of interest, the layout regions of interest comprising a plurality of hotspot layout regions;
determining feature values for a plurality of design/process-related features for each of the layout regions of interest;
determining population ratios for feature value ranges for each of the plurality of design/process-related features based on a number of layout regions of interest having feature values within each of the feature value ranges;
determining hotspot feature repeater values, a hotspot feature repeater value for a feature value range for a design/process-related feature being associated with a number of hotspot layout regions in the feature value range;
performing a root cause analysis to determine, for each of the plurality of hotspot layout regions, one or more design/process-related features that are most likely causes of the each of the plurality of hotspot layout regions based on the population ratios and the hotspot feature repeater values; and
storing information of the one or more design/process-related features for each of the plurality of hotspot layout regions.

10. The one or more computer-readable media recited in claim 9, wherein the method further comprises:
identifying hotspot layout regions in another layout design or additional hotspot layout regions in the layout design based on the information of the one or more design/process-related features for each of the plurality of hotspot layout regions; and
adjusting the another layout design or the layout design based on the identified hotspot layout regions or the identified additional hotspot layout regions.

11. The one or more computer-readable media recited in claim 9, wherein the method further comprises:
adjusting a manufacturing process based on the information of the one or more design/process-related features for each of the plurality of hotspot layout regions.

12. The one or more computer-readable media recited in claim 9, wherein the root cause analysis comprises a decision chain process for each of the plurality of hotspot layout regions.

13. The one or more computer-readable media recited in claim 12, wherein the decision chain process comprises:
selecting a hotspot layout region;
determining an initial design/process-related feature that is a most likely cause of the selected hotspot layout region based on a statistic model, the population ratios, and the hotspot feature repeater values;
identifying, for subsequent analysis, layout regions of interest having feature values within a feature value range for the initial design/process-related feature in which a feature value for the selected hotspot layout region is;
determining another design/process-related feature that is a next most likely cause of the selected hotspot layout region based on the statistic model, updated population ratios, and updated hotspot feature repeater values, the updated population ratios and the updated hotspot feature repeater values derived based on the identified layout regions of interest; and
repeating the identifying and the determining another design/process-related feature by replacing the initial design/process-related feature with the another design/process-related feature until a predetermined condition is met.

14. The one or more non-transitory computer-readable media recited in claim 13, wherein the predetermined condition is based on a predetermined p-value.

15. The one or more non-transitory computer-readable media recited in claim 13, wherein the statistic model comprises:
computing a probability value for hotspot layout regions having feature values within feature value ranges for each of the process-related features where a corresponding feature value for the selected hotspot layout region is.

16. The one or more non-transitory computer-readable media recited in claim 15, wherein the computing is based on a binomial distribution.

17. A system, comprising:
one or more processors, the one or more processors programmed to perform a method, the method comprising:
receiving a layout design, the layout design having layout regions of interest, the layout regions of interest comprising a plurality of hotspot layout regions;
determining feature values for a plurality of design/process-related features for each of the layout regions of interest;
determining population ratios for feature value ranges for each of the plurality of design/process-related features based on a number of layout regions of interest having feature values within each of the feature value ranges;
determining hotspot feature repeater values, a hotspot feature repeater value for a feature value range for a design/process-related feature being associated with a number of hotspot layout regions in the feature value range;
performing a root cause analysis to determine, for each of the plurality of hotspot layout regions, one or more design/process-related features that are most likely causes of the each of the plurality of hotspot layout regions based on the population ratios and the hotspot feature repeater values; and
storing information of the one or more design/process-related features for each of the plurality of hotspot layout regions.

18. The system recited in claim 17, wherein the method further comprises:
adjusting the layout design or a manufacturing process based on the information of the one or more design/process-related features for each of the plurality of hotspot layout regions.

19. The system recited in claim 17, wherein the root cause analysis comprises a decision chain process for each of the plurality of hotspot layout regions.

20. The system recited in claim 19, wherein the decision chain process comprises:
selecting a hotspot layout region;
determining an initial design/process-related feature that is a most likely cause of the selected hotspot layout region based on a statistic model, the population ratios, and the hotspot feature repeater values;
identifying, for subsequent analysis, layout regions of interest having feature values within a feature value range for the initial design/process-related feature in which a feature value for the selected hotspot layout region is;
determining another design/process-related feature that is a next most likely cause of the selected hotspot layout region based on the statistic model, updated population ratios, and updated hotspot feature repeater values, the updated population ratios and the updated hotspot feature repeater values derived based on the identified layout regions of interest; and
repeating the identifying and the determining another design/process-related feature by replacing the initial design/process-related feature with the another design/process-related feature until a predetermined condition is met.
